(19) United States
(12) Patent Application Publication
(10) Pub. No.: US 2014/0045960 A1
(43) Pub. Date: Feb. 13, 2014

(54) POLYURETHANE FOAM AND METHOD FOR PRODUCING SAME

(71) Applicants: Stefan Lindner, Koln (DE); Wolfgang Friederichs, Koln (DE); Reinhard Strey, Dormagen (DE); Thomas Sottman, Koln (DE); Diana Engelen, Leverkusen (DE); Agnes Dominika Chalbi, Hurth (DE); Nils Becker, Koln (DE)

(72) Inventors: Stefan Lindner, Koln (DE); Wolfgang Friederichs, Koln (DE); Reinhard Strey, Dormagen (DE); Thomas Sottman, Koln (DE); Diana Engelen, Leverkusen (DE); Agnes Dominika Chalbi, Hurth (DE); Nils Becker, Koln (DE)

(73) Assignee: Bayer Intellectual Property GmbH Creative Campus Monheim, Monheim (DE)

(21) Appl. No.: 14/113,869

(22) PCT Filed: Apr. 24, 2012
(86) PCT No.: PCT/EP2012/057427

§ 371 Date: Oct. 25, 2013

(30) Foreign Application Priority Data
Apr. 29, 2011 (DE) 10 2011 050 013.8

(51) Int. Cl. C08J 9/14; C08J 9/12; C08G 71/04

(52) U.S. Cl. CPC C08J 9/142; C08G 71/04; C08J 9/122
USPC 521/116; 521/160

(57) ABSTRACT

A polyurethane foam is obtainable from the reaction of a mixture comprising A) an isocyanate-reactive compound; B) a blowing agent selected from the group comprising linear, branched or cyclic C₁-C₆ hydrocarbons, linear, branched or cyclic C₁-C₆ (hydro)fluorocarbons, N₂, O₂, argon and/or CO₂, wherein said blowing agent B) is in the supercritical or near-critical state; and C) a polyisocyanate.

The isocyanate-reactive compound A) comprises a hydrophobic portion and a hydrophilic portion and has an average hydroxyl functionality of more than 1. The hydrophobic portion comprises a saturated or unsaturated hydrocarbonaceous chain having 6 or more carbon atoms and the hydrophilic portion comprises alkylene oxide units and/or ester units. Component A) is very preferably a sorbutan ester of the formula (II):

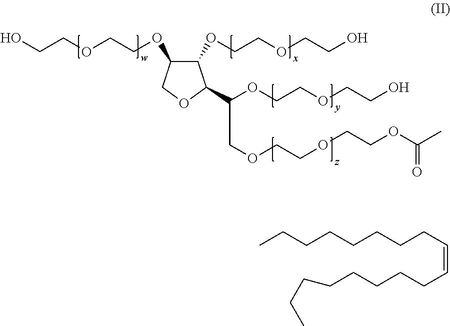

where w+x+y+z=20.

The present invention relates to a polyurethane foam obtainable from the reaction of a mixture comprising A) an isocyanate-reactive compound; B) a blowing agent selected from the group comprising linear, branched or cyclic C₁-C₆ hydrocarbons, linear, branched or cyclic C₁-C₆ (hydro)fluorocarbons, N₂, O₂, argon and/or CO₂, wherein said blowing agent B) is in the supercritical or near-critical state; and C) a polyisocyanate.

The invention further relates to a method for producing such a polyurethane foam.

Nanocellular or nanoporous polymer foams are particularly good thermal insulation materials on the basis of theoretical considerations. This is because the internal dimensions of nanofoams are of the order of the mean free path of a gas molecule. The gas contribution to heat transfer can be reduced in this way. Polyurethanes are a group of polymers which are frequently used in thermal insulation.

Polyurethane foams are produced by reacting a polyol component, which also contains a blowing agent, with an isocyanate. The reaction of isocyanate with water gives rise to carbon dioxide, which also acts as a blowing agent.

The decisive step for foam formation, and hence for the later cell size of the cured foam, is the nucleation provided by blowing agents, since every cell in the foam has been formed from a gas bubble. A relevant observation here is that, after nucleation, no new gas bubbles are generally produced, but instead blowing agent diffuses into existing gas bubbles.

Addition of stabilizers promotes the emulsification of the various components, influences nucleation and inhibits coalescence of growing gas bubbles. They also influence cell opening. In open-cell foams, the membranes of the growing pores are opened and the struts of the pores are left standing.

One possible approach is to emulsify a supercritical blowing agent into the reaction mixture and then to cure the foam after reducing the pressure. The POSME method (principle of supercritical micro emulsion expansion) is known as a variant thereof. The blowing agent is present therein in the form of a microemulsion. Microemulsions form under certain conditions which depend inter alia on the concentration of emulsifiers and on the temperature. Microemulsions are notable for their stability and for the fact that the apolar phase, i.e., the blowing agent in this case, can be present within the polar phase in very small droplets. The diameters of such droplets can range from 1 to 100 nanometers.

DE 102 60 815 A1 discloses foamed material and a method of making the foamed material. Foamed material comprising foam bubbles in nanosize is supposed to be produced without having to surmount the energy barrier typical of phase conversions and nucleus-forming processes. An associated goal is to produce, in a controllable manner, a foamed material that has a numeric density of foam bubbles between 10¹² and 10¹⁸ per cm³ and also an average diameter for the foam bubbles of between 10 nm and 10 μm. The foundation is the dispersion of a second fluid in the form of pools in a matrix of a first fluid. A reaction space contains the first fluid as a matrix and a second fluid in pools. A change in pressure and/or temperature is used to convert the second fluid into a near-critical or supercritical state with a density close to that of a liquid. The second fluid is therefore fully or almost fully in the form of pools which have a uniform distribution in the entire first fluid. Depressurization causes the second fluid to revert to a state of gaseous density, while the pools inflate into foam bubbles of nanometer size. No energy barrier has to be surmounted, nor do the blowing agent molecules have to diffuse to the expanding bubbles.

Any polymerizable substance is said to be generally useful as first fluid. However, express mention is only made of acrylamide, which polymerizes to give polyacrylamide, and melamine, which polymerizes to give melamine resin. The second fluid is supposed to be selected from a group of materials which comprises hydrocarbons such as methane or ethane, alkanols, (hydro)chlorofluorocarbons or CO₂. A further material used is an amphiphilic material that is supposed to have at least one block with affinity for the first fluid and at least one block with affinity for the second fluid.

WO 2007/094780 A1 discloses with respect to polyurethane foams a resin composition comprising a polyol, and ethoxylated/propoxylated surfactant initiated with a short-chain compound and also a hydrocarbon blowing agent. The solubility and/or compatibility of the hydrocarbon blowing agent is increased and the phase stability of the resin composition is improved by the ethoxylated/propoxylated surfactant. The resin composition is suitable for reaction with polyfunctional organic isocyanates to produce cellular polyurethane and polyisocyanurate foams.

The surfactants are obtained by reacting ethylene oxide and propylene oxide with an initiator selected from the group of compounds having one alkylene oxide active hydrogen atom and a C₁-C₆ aliphatic or alicyclic hydrocarbonaceous group, compounds having one alkylene oxide active hydrogen atom and a C₆-C₁₀ aryl or alkylaryl hydrocarbonaceous group, and combinations thereof. The initiator is preferably selected from the group consisting of C₁-C₆ aliphatic or alicyclic alcohols, phenol, C₁-C₄ alkylphenols, and combinations thereof.

A butanol-initiated propylene oxide-ethylene oxide surfactant is mentioned as an example. Alternatively, the surfactant can further comprise an alkoxylated triglyceride adduct or an ethoxylated derivative of a sorbitan ester. The blowing agent can be a C₄-C₇ aliphatic hydrocarbon, a C₄-C₇ cycloaliphatic hydrocarbon or a combination thereof. Pentanes are mentioned as an example.

However, the examples mentioned do not disclose a polyol composition in which the blowing agent is in the form of a microemulsion as a result of the choice of surfactant.

Specific siloxane surfactants are one of the concerns in US 2005/0131090 A1. A method is disclosed therein for producing rigid polyurethane foams by reacting a polyisocyanate and a polyol in the presence of a urethanization catalyst, a blowing agent, optionally water and a silicone surfactant. C₄ or C₅ hydrocarbons or mixtures thereof are used as blowing agents. The blowing agents have an average molecular weight of ≦72 g/mol and a boiling point in the range from 27.8 to 50° C. The silicone surfactant comprises a polyether-polysiloxane copolymer represented by the following general formula: (CH₃)₃—Si—O—(Si(CH₃)₂—O)ₓ—(Si(CH₃)(R)O)_{y}—Si(CH₃)₃, where:

R═(CH₂)₃—O—(—CH₂—CH₂—O)ₐ—(CH₂—CH(CH₃)—O)_{b}—R″ and where R″ represents H, (CH₂)_{Z}CH₃ or C(O)CH₃. Furthermore, x+y+2 is 60-130, x/y is 5-14 and z is 0-4. Total surfactant molecular weight, based on the formula, is 7000-30 000 g/mol. The weight fraction of siloxane in the surfactant is 32-70 wt %, the blend average molecular weight (BAMW) of the polyether fraction is 450-1000 g/mol and the ethylene oxide content, expressed in mol %, of the polyether fraction is 70-100 mol %. However, this publication does not relate to microemulsions or blowing agents in the supercritical state. Rather, the siloxane surfactant is used as a cell-stabilizing agent.

GB 2 365 013 A discloses alkylene oxide-modified silicone glycols for stable polyester polyol compositions. A polyester polyol composition comprises a phthalic anhydride-initiated polyester polyol, a C₄-C₆ hydrocarbon blowing agent, and an alkylene-modified silicone glycol compatibilizing agent having an HLB value of about 5 to about 8. The blowing agent is soluble in the polyol composition, thereby reducing the risks associated with such blowing agents in the production of rigid polymer foam articles. Rigid foams having good dimensional stability and improved insulation properties are provided. An isocyanate-modified silicone glycol compatibilizing agent is also disclosed.

This application for a patent discloses that, in some cases, a certain blowing agent will form a microemulsion with the polyol and other components. What is not disclosed, however, is whether the blowing agent is under supercritical conditions at this stage. Rather, the reference to microemulsions relates to the test for determining the storage stability of polyol compositions. In this test, a polyol composition and the blowing agent are mixed in a glass jar and the jar is capped, shaken and stored at room temperature for five days. When no phase separation occurs, the blowing agent is deemed soluble in the polyol composition and the composition is deemed storage stable. However, storage in a capped glass jar at room temperature is unlikely to give rise to conditions under which a C₄-C₆ hydrocarbon is in the supercritical state.

It is further stated in this application for a patent that the starting materials for producing foams can be introduced into an open or closed mold at a temperature of 15° C. to 90° C. and preferably of 20° C. to 35° C. A superatmospheric pressure can be employed for this. The mixing of the isocyanate with the polyol composition containing dissolved blowing agent can be carried out by stirring or under high pressure by injection. The temperature of the mold can be in the range from 20° C. to 110° C., preferably in the range from 30° C. to 60° C. and especially in the range from 45° C. to 50° C. Again there is no indication here that conditions for the blowing agent are supercritical.

Sudden depressurization of CO₂-containing reaction mixtures is described in WO 2001/98389 A1. This application for a patent relates to a method for producing polyurethane slabstock foam wherein a reactive polyurethane mixture comprising carbon dioxide is abruptly depressurized from a pressure above the equilibrium solution pressure of the carbon dioxide to atmospheric pressure. As dissolved carbon dioxide escapes, the reactive liquid polyurethane mixture foams up; the foamed-up mixture is applied to a substrate and then cures to form the slabstock foam. The carbon dioxide is first fully dissolved in the reactive mixture, or in either or both of the components, polyol and isocyanate, at a pressure substantially above the equilibrium solution pressure. The pressure is then reduced to a pressure close to the equilibrium solution pressure by transiently dipping below the equilibrium solution pressure to evolve small amounts of the carbon dioxide and form a microdispersion of bubbles, mixing the components if appropriate, and the abrupt reduction in pressure to atmospheric pressure takes place before the evolved carbon dioxide is completely redissolved. However, there are no pointers here to nanocellular foams or supercritical conditions for the blowing agent.

US 2004/0054022 A1 discloses a preparation method for rigid polyurethane foam having a density of 20 to 40 kg/m³ and an average value of 1.0 to 1.4 for the ratio of cell lengthwise-direction diameter to cross-direction diameter. The blowing agent used is CO₂ generated in the reaction between water and polyisocyanates plus supercritical, subcritical or liquid CO₂. Before mixing with the polyisocyanate, water and the liquid CO₂ are added to the polyol. Preferred CO₂ contents are between 0.5% and 3%. This makes sense bearing in mind that larger amounts of CO₂ would risk sudden vaporization.

However, the particularly fluorine- and silicone-containing surfactants used for stabilizing supercritical CO₂ in an emulsion are comparatively costly. It is an object of the present invention to specify a polyurethane foam and its method of production wherein a less costly surfactant can be used for stabilizing microemulsions of the blowing agent.

We have found that this object is achieved according to the present invention by a polyurethane foam obtainable from the reaction of a mixture comprising:
A) an isocyanate-reactive compound;
B) a blowing agent selected from the group comprising linear, branched or cyclic C₁-C₆ hydrocarbons, linear, branched or cyclic C₁-C₆ (hydro)fluorocarbons, N₂, O₂, argon and/or CO₂, wherein said blowing agent B) is in the supercritical or near-critical state; and
C) a polyisocyanate;
   wherein said isocyanate-reactive compound A) comprises a hydrophobic portion and a hydrophilic portion and has an average hydroxyl functionality of more than 1, wherein the hydrophobic portion comprises a saturated or unsaturated hydrocarbonaceous chain having 6 or more carbon atoms, and wherein the hydrophilic portion comprises alkylene oxide units and/or ester units.

It was found that, surprisingly, the choice of compound A) according to the present invention makes it possible to produce microemulsions of the blowing agent, especially CO₂, which are further processable into polyurethane foams. As a result, the blowing agent is in a fine state of subdivision in its own phase, making it possible to produce foams which are particularly finely cellular. Use of the blowing agent mixture in the supercritical or near-critical state does away with the need for a nucleation step. This is the reason why the production of finely cellular foams is possible. Component A) can be regarded as a surfactant, but also as a polyol and thus as a co-reactant for polyisocyanates. The present invention also comprehends the possibility that component A) represents the main or even sole NCO-reactive component in any one polyurethane formulation.

According to the present invention, isocyanate-reactive compound A) comprises a hydrophilic region and a hydrophobic region. The hydrophilic and lipophilic content of surfactants is described by the HLB (hydrophilic-lipophilic balance) value. The HLB value of nonionic surfactants can be computed as follows: HLB=20×(1−Mₕ/M), where Mₕ is the molar mass of the hydrophobic moiety of a molecule and M is the molar mass of the entire molecule. The HLB value of isocyanate-reactive compound A) can be for example between 4 and 18, preferably between 8 and 16 and more preferably between 10 and 15. The hydrophobic portion comprises a saturated or unsaturated hydrocarbonaceous chain of at least 6 carbon atoms, preferably at least 8 carbon atoms, more preferably at least 12 carbon atoms and most preferably at least 14 carbon atoms.

Saturated hydrocarbonaceous chains in isocyanate-reactive compound A) are obtainable, for example, by esterification of polyols with saturated fatty acids. 2-Ethylhexanoic acid is one example of a suitable saturated fatty acid. Unsaturated hydrocarbonaceous chains, in addition to units of the form —(H)C═C(H)—, may of course also contain saturated units —CH₂—. This can be achieved by esterification with unsaturated fatty acids. Oleic acid ((Z)-9-octadecenoic acid) is one example of a suitable unsaturated fatty acid. Mixtures of fatty acids, obtained from natural oils such as soybean oil or rapeseed oil for example, can also be used.

Isocyanate-reactive compound A) is preferably a compound which is liquid at 20° C., preferably having a viscosity of less than 15 000 mPas and more preferably below 5000 mPas. Viscosity can be determined by the method of DIN 53019 for example.

The hydrophilic region of isocyanate-reactive compound A) preferably comprises ethylene oxide units —[—CH₂—CH₂—O—]— and/or carboxylic ester units. Compound A) is obtainable, for example, by partially alkoxylating an at least trifunctional polyol, so one OH group of the polyol is available for an esterification with a fatty acid. Compound A) is further obtainable by an esterification of oleic acid with adipic acid, trimethylolpropane and/or diethylene glycol, for example. The average number of OH groups per molecule of isocyanate-reactive compound A) is preferably in the range from 1.5 to 5 and more preferably in the range from 2.5 to 3.5.

Supercritical or near-critical blowing agent B) is used to produce the polyurethane foam. Conditions are near-critical in the context of the present invention when the following condition is satisfied: (T_{c}−T)/T≦0.4 and/or (p_{c}−p)/p≦0.4, where T is the temperature prevailing in the process, T_{c} is the critical temperature of the blowing agent or blowing agent mixture, p is the pressure prevailing in the process and p_{c} is the critical pressure for the blowing agent or blowing agent mixture. Conditions are preferably near-critical when: (T_{c}−T)/T≦0.3 and/or (p_{c}−p)/p≦0.3 and more preferably (T_{c}−T)/T≦0.2 and/or (p_{c}−p)/p≦0.2. Without wishing to be tied to any one theory, it is believed that the choice of suitable surfactant components ensures that emulsions or microemulsions of the supercritical or near-critical blowing agent form in the phase comprising isocyanate-reactive components.

The blowing agent may preferably form its own phase in the reaction mixture. Supercritical carbon dioxide can be used for example. The carbon dioxide can be formed during the reaction to form the polyurethane foam, for example as a result of the reaction of isocyanates with water or with acids. Examples of further blowing agents are linear C₁-C₆ hydrocarbons, branched C₄-C₆ hydrocarbons and cyclic C₃-C₆ hydrocarbons. Specific examples of blowing agents are methane, ethane, propane, n-butane, isobutane, n-pentane, isopentane, cyclopentane, isohexane and/or cyclohexane. Further examples are the partially or perfluorinated derivatives of methane, ethane, propane, n-butane, isobutane, n-pentane, isopentane, cyclopentane, hexane, isohexane, 2,3-dimethylbutane and/or cyclohexane. Preference is given to using carbon dioxide or a blowing agent mixture having a carbon dioxide content of more than 30% by weight, preferably more than 50% by weight and more preferably more than 70% by weight.

The proportion of blowing agent in the reaction mixture comprising components A) and B), but not C), can be ≧5% by weight to ≦60% by weight for example.

Component C) is a polyisocyanate, i.e., an isocyanate having an NCO functionality of ≧2. The reaction mixture, then, can therefore react to give polyurethane foams or else to give polyisocyanurate foams. This reaction mixture can be produced directly in a mixing head.

Examples of suitable polyisocyanates of this type are 1,4-butylene diisocyanate, 1,5-pentane diisocyanate, 1,6-hexamethylene diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or their mixtures of any desired isomer content, 1,4-cyclohexylene diisocyanate, 1,4-phenylene diisocyanate, 2,4- and/or 2,6-tolylene diisocyanate (TDI), 1,5-naphthylene diisocyanate, 2,2′- and/or 2,4′- and/or 4,4′-diphenylmethane diisocyanate (MDI) and/or higher homologs (polymeric MDI), 1,3- and/or 1,4-bis(2-isocyanatoprop-2-yl)benzene (TMXDI), 1,3-bis-(isocyanatomethyl)benzene (XDI), and also alkyl 2,6-diisocyanatohexanoates (lysine diisocyanates) having C₁ to C₆ alkyl groups. An isocyanate from the diphenylmethane diisocyanate series is preferred.

In addition to the aforementioned polyisocyanates, it is also possible to make concomitant use of proportions of modified diisocyanates of uretdione, isocyanurate, urethane, carbodiimide, uretoneimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

The isocyanate can be a prepolymer obtainable by reacting an isocyanate having an NCO functionality of ≧2 and polyols having a molecular weight of ≧62 g/mol to ≦8000 g/mol and OH functionalities of ≧1.5 to ≦6.

It will be appreciated that still further customary auxiliary and added substances such as catalysts, flame retardants, release agents, fillers and the like can be used to produce the polyurethane foam.

The number of NCO groups in polyisocyanate component D) and the number of isocyanate-reactive groups of component A) can be in a numerical ratio of ≧50:100 to ≦500:100 relative to each other for example. This index can also be in a range of ≧160:100 to ≦330:100 or else ≧80:100 to ≦140:100.

The mixture comprising components A), B) and C) is obtainable for example by initially charging all the components other than the polyisocyanate component to a high-pressure mixing head under conditions supercritical or near-critical for the blowing agent and then admixing them with polyisocyanate C).

Suitable pressures for producing the polyurethane foam can be in the range from ≧40 bar to ≦300 bar for example. Suitable temperatures are ≧10° C. to ≦80° C. for example, preferably ≧25° C. to ≦60° C. Particular preference is given to pressures and temperatures above the critical point of CO₂, i.e., ≧73.7 bar and ≧31° C.

When additional NCO-reactive compounds in the reaction mixture are contemplated, especially polyols, polyamines, polyaminoalcohols and polythiols can be used.

Examples of polyamines are ethylenediamine, 1,2-diaminopropane, 1,3-diaminopropane, 1,4-diaminobutane, 1,6-diaminohexane, isophoronediamine, an isomeric mixture of 2,2,4- and 2,4,4-trimethylhexamethylenediamine, 2-methylpentamethylenediamine, diethylenetriamine, 1,3-xylylenediamine, 1,4-xylylenediamine, α,α,α′,α′-tetramethyl-1,3-xylylenediamine, α,α,α′,α′-tetramethyl-1,4-xylylenediamine, 4,4′-diaminodicyclohexylmethane, diethylmethylbenzenediamine (DETDA), 4,4′-diamino-3,3′-dichlorodiphenylmethanes (MOCAs), dimethylethylenediamine, 1,4-bis(aminomethyl)cyclohexane, 4,4′-diamino-3,3′-dimethyldicyclohexylmethane and 4,4′-diamino-3,5-diethyl-3′,5′-diisopropyldicyclohexylmethane. Polymeric polyamines such as polyoxyalkyleneamines are also suitable.

Examples of aminoalcohols are N-aminoethylethanolamine, ethanolamine, 3-aminopropanol, neopentanolamine and diethanolamine.

Examples of polythiols are di(2-mercaptoethyl)ether, pentaerythritol tetrakisthioglycolate, pentaerythritol tetrakis(3-mercaptopropionate) and 1,2-bis((2-mercaptoethyl)thio)-3-mercaptopropane.

Polyols can for example have a number-average molecular weight Mₙ of ≧62 g/mol to ≦8000 g/mol, preferably of ≧90 g/mol to ≦5000 g/mol and more preferably of ≧92 g/mol to ≦1000 g/mol. In the case of a single added polyol, the OH number of component A) indicates the OH number thereof. In the case of mixtures, the average OH number is reported. This value can be determined in accordance with DIN 53240. The average OH functionality of the recited polyols is for example ≧2, for example in a range from ≧2 to ≦6, preferably from ≧2.1 to ≦4 and more preferably from ≧2.2 to ≦3.

Examples of polyether polyols that can be used are the polytetramethylene glycol polyethers that are obtainable through polymerization of tetrahydrofuran via cationic ring opening.

Useful polyether polyols further include addition products of styrene oxide, ethylene oxide, propylene oxide, butylene oxides and/or epichlorohydrin onto di- or polyfunctional starter molecules.

Examples of suitable starter molecules are water, ethylene glycol, diethylene glycol, butyl diglycol, glycerol, diethylene glycol, trimethylolpropane, propylene glycol, pentaerythritol, sorbitol, sucrose, ethylenediamine, toluenediamine, triethanolamine, 1,4-butanediol, 1,6-hexanediol and also low molecular weight hydroxyl-containing esters of polyols of this type with dicarboxylic acids.

Suitable polyester polyols include polycondensates of di- and also tri- and tetraols and di- and also tri- and tetracarboxylic acids or of hydroxycarboxylic acids or of lactones. Instead of the free polycarboxylic acids it is also possible to use the corresponding polycarboxylic anhydrides, or corresponding polycarboxylic esters of lower alcohols, to produce the polyesters.

Examples of suitable diols are ethylene glycol, butylene glycol, diethylene glycol, triethylene glycol, polyalkylene glycols such as polyethylene glycol, also 1,2-propanediol, 1,3-propanediol, 1,3-butanediol, 1,4-butanediol, 1,6-hexanediol and isomers, neopentyl glycol or neopentyl glycol hydroxypivalate. Other polyols that can be used, alongside these, are those such as trimethylolpropane, glycerol, erythritol, pentaerythritol, trimethylolbenzene or trishydroxyethyl isocyanurate.

Examples of polycarboxylic acids that can be used are phthalic acid, isophthalic acid, terephthalic acid, tetrahydrophthalic acid, hexahydrophthalic acid, cyclohexanedicarboxylic acid, adipic acid, azelaic acid, sebacic acid, glutaric acid, tetrachlorophthalic acid, maleic acid, fumaric acid, itaconic acid, malonic acid, suberic acid, succinic acid, 2-methylsuccinic acid, 3,3-diethylglutaric acid, 2,2-dimethylsuccinic acid, dodecanedioic acid, endomethylenetetrahydrophthalic acid, dimer fatty acid, trimer fatty acid, citric acid, or trimellitic acid. It is also possible to use the corresponding anhydrides as acid source.

To the extent that the average functionality of the polyol to be esterified is ≧2, it is also possible to make additional concomitant use of monocarboxylic acids such as benzoic acid and hexanecarboxylic acid.

Examples of hydroxycarboxylic acids which can be used concomitantly as reactants during the production of a polyester polyol having terminal hydroxyl groups are hydroxycaproic acid, hydroxybutyric acid, hydroxydecanoic acid, hydroxystearic acid and the like. Suitable lactones include caprolactone, butyrolactone and homologs.

Polycarbonate polyols that can be used according to the present invention are hydroxyl-containing polycarbonates, for example polycarbonate diols. These are obtainable through reaction of carbonic acid derivatives, such as diphenyl carbonate, dimethyl carbonate or phosgene, with polyols, preferably diols, or through the copolymerization of alkylene oxides such as propylene oxide with CO₂.

Examples of diols of this type are ethylene glycol, 1,2-propanediol, 1,3-propanediol, 1,3-butanediol, 1,4-butanediol, 1,6-hexanediol, 1,8-octanediol, neopentyl glycol, 1,4-bishydroxy-methylcyclohexane, 2-methyl-1,3-propanediol, 2,2,4-trimethyl-1,3-pentanediol, dipropylene glycol, polypropylene glycols, dibutylene glycol, polybutylene glycols, bisphenol A and lactone-modified diols of the aforementioned type.

Instead of or in addition to pure polycarbonate diols, it is also possible to use polyether-polycarbonate diols.

Polyetherester polyols that can be used are compounds that contain ether groups, ester groups and OH groups. Suitable compounds for producing the polyetherester polyols are organic dicarboxylic acids having up to 12 carbon atoms, preferably aliphatic dicarboxylic acids having ≧4 to ≦6 carbon atoms or aromatic dicarboxylic acids, which are used individually or in a mixture. Examples that may be mentioned are suberic acid, azelaic acid, decanedicarboxylic acid, maleic acid, malonic acid, phthalic acid, pimelic acid and sebacic acid and also particularly glutaric acid, fumaric acid, succinic acid, adipic acid, phthalic acid, terephthalic acid and isoterephthalic acid. Examples of derivatives of said acids that can be used are their anhydrides and also their esters and hemiesters with low molecular weight monohydric alcohols having ≧1 to ≦4 carbon atoms.

Another component used for producing the polyetherester polyols are polyether polyols obtained through alkoxylation of starter molecules such as polyhydric alcohols. The starter molecules are at least difunctional, but can also optionally contain proportions of starter molecules of higher functionality, especially trifunctional starter molecules.

Examples of starter molecules are diols having number-average molecular weights Mₙ of preferably ≧18 g/mol to ≦400 g/mol or of ≧62 g/mol to ≦200 g/mol such as 1,2-ethanediol, 1,3-propanediol, 1,2-propanediol, 1,4-butanediol, 1,5-pentenediol, 1,5-pentanediol, neopentyl glycol, 1,6-hexanediol, 1,7-heptanediol, 1,8-octanediol, 1,10-decanediol, 2-methyl-1,3-propanediol, 2,2-dimethyl-1,3-propanediol, 3-methyl-1,5-pentanediol, 2-butyl-2-ethyl-1,3-propanediol, 2-butene-1,4-diol and 2-butyne-1,4-diol, ether diols such as diethylene glycol, triethylene glycol, tetraethylene glycol, dibutylene glycol, tributylene glycol, tetrabutylene glycol, dihexylene glycol, trihexylene glycol, tetrahexylene glycol and oligomer mixtures of alkylene glycols, such as diethylene glycol.

Polyols having number-average functionalities of >2 to ≦8, or of ≧3 to ≦4 can also be used concomitantly alongside the diols, examples being 1,1,1-trimethylolpropane, triethanolamine, glycerol, sorbitan and pentaerythritol, and also polyethylene oxide polyols started on triols or tetraols and having average molecular weights of preferably ≧62 g/mol to ≦400 g/mol or of ≧92 g/mol to ≦200 g/mol.

Polyetherester polyols are also obtainable through the alkoxylation of reaction products which are obtained by the reaction of organic dicarboxylic acids and diols. Examples of derivatives of said acids that can be used are their anyhdrides, for example phthalic anhydride.

Polyacrylate polyols are obtainable through free-radical polymerization of hydroxyl-containing olefinically unsaturated monomers or through free-radical copolymerization of hydroxyl-containing olefinically unsaturated monomers with optionally other olefinically unsaturated monomers. Examples thereof are ethyl acrylate, butyl acrylate, 2-ethylhexyl acrylate, isobornyl acrylate, methyl methacrylate, ethyl methacrylate, butyl methacrylate, cyclohexyl methacrylate, isobornyl methacrylate, styrene, acrylic acid, acrylonitrile and/or methacrylonitrile. Suitable hydroxyl-containing olefinically unsaturated monomers are in particular 2-hydroxyethyl acrylate, 2-hydroxyethyl methacrylate, the hydroxypropyl acrylate isomer mixture obtainable through addition of propylene oxide onto acrylic acid and also the hydroxypropyl methacrylate isomer mixture obtainable through addition of propylene oxide onto methacrylic acid. Terminal hydroxyl groups can also be present in protected form. Suitable free-radical initiators are those from the group of the azo compounds, e.g., azoisobutyronitrile (AIBN), or from the group of the peroxides, e.g., di-tert-butyl peroxide.

Preferred embodiments of the method according to the present invention will now be more particularly described. They can be combined in any desired manner unless the contrary is apparent from the context.

In one embodiment, the isocyanate-reactive compound has an average hydroxyl functionality of ≧1.5 to ≦5. This functionality is preferably ≧1.8 to ≦2.2.

In a further embodiment, isocyanate-reactive compound A) has a hydroxyl number of ≧50 mg KOH/g to ≦500 mg KOH/g. This value can be determined by the method of DIN 53240. Preferred ranges for the OH numbers are ≧70 mg KOH/g to ≦400 mg KOH/g and more preferably ≧100 mg KOH/g to ≦300 mg KOH/g. In the case of mixtures, this is to be understood as referring to the average OH number.

In a further embodiment, the proportion of said isocyanate-reactive compound A) is ≧0.5% by weight to ≦40% by weight, based on the overall weight of the mixture. The proportion is preferably ≧2% by weight to ≦30% by weight and more preferably ≧5% by weight to ≦20% by weight.

In a further embodiment, the hydrophilic portion of said isocyanate-reactive compound A) comprises an intro-esterified fatty acid and the proportion of the intro-esterified fatty acid is ≧0.5% by weight to ≦25% by weight, based on the overall weight of the mixture. Preferred proportions are ≧2% by weight to ≦15% by weight and more preferably are ≧4% by weight to ≦10% by weight.

In a further embodiment, said isocyanate-reactive compound A) is obtainable from the reaction of a partially alkoxylated polyol with a fatty acid.

Preferably, said isocyanate-reactive compound A) comprises a carboxylic ester of an alkoxylated sorbitan.

It is further preferable for the isocyanate-reactive compound to be an ester of the general formula (I):

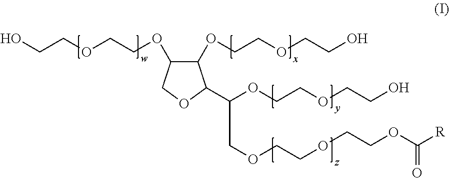

where w+x+y+z≧16 to ≦22 and R is a saturated or unsaturated hydrocarbonaceous moiety of ≧12 to ≦18 carbon atoms.

A particularly preferred example is polysorbate 80 which is described by formula (II):

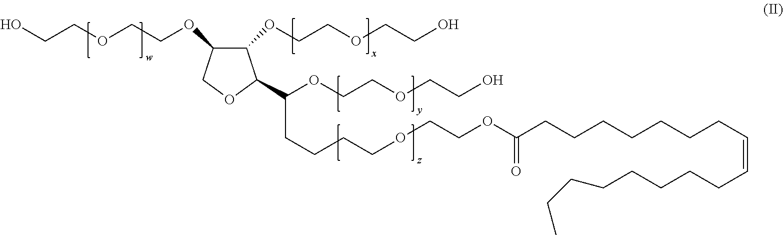

where w+x+y+z=20.

In a further embodiment, said isocyanate-reactive component A) comprises a polyetherester polyol having a hydroxyl number of ≧200 mg KOH/g to ≦600 mg KOH/g and a short-chain polyol having a hydroxyl number of ≧800 mg KOH/g. Suitable polyetherester polyols include bifunctional polyetherester polyols which are obtained by addition of alkylene oxides and especially ethylene oxide onto a mixture of phthalic anhydride, diethylene glycol and ethylenediamine and have an OH number of ≧275 mg KOH/g to ≦325 mg KOH/g.

Products of this type are available from Bayer MaterialScience AG under the trade name of Desmophen® VP.PU 1431. The OH number of the polyester polyol can also be ≧290 mg KOH/g to ≦320 mg KOH/g. Short-chain polyols are polyols having ≧2 to ≦56 carbon atoms in particular. Glycerol is preferred. It has an OH number of 1827 mg KOH/g. Adding the short-chain polyol is a favorable way to increase the polarity of the polyol phase.

In a further embodiment, the proportion of blowing agent B) is ≧2% by weight to ≦10% by weight, based on the overall weight of the mixture. Preferred proportions are ≧4% by weight to ≦8% by weight.

In a further embodiment, said polyisocyanate component C) comprises monomeric and/or polymeric diphenylmethane 4,4′-diisocyanate. A polyisocyanate of this type is available from Bayer MaterialScience under the trade name of Desmodur® 44V70L as a mixture of diphenylmethane 4,4′-diisocyanate (MDI) with isomers and higher-functional homologs.

In a further embodiment, the polyurethane foam has an apparent density of ≧20 kg/m³ to ≦160 kg/m³. Apparent density can be determined according to DIN EN 1602 and is preferably ≧30 kg/m³ to ≦120 kg/m³ and more preferably ≧50 kg/m³ to ≦80 kg/m³. Preferred uses for the foam of the present invention are in thermal insulation, for example for the production of insulation panels, metal composite panels or for refrigerator insulation.

The present invention further provides a method for producing a polyurethane foam comprising the steps of:
providing a mixture of compounds A) B) and C) as described above in a mixing head; and
discharging the mixture from the mixing head, wherein the pressure prevailing in the mixture is lowered to atmospheric pressure in the course of discharge.

In the step of discharging the mixture from the mixing head the pressure prevailing in the mixture lowered to atmospheric pressure. Atmospheric pressure herein is to be understood as meaning a pressure of ≧0.9 bar to ≦1.1 bar in particular. The blowing agent goes into the subcritical state and preferably into the gaseous state. For example, the reaction mixture can simply be introduced into an open mold from the mixing head or be used in a continuous manner for the production of sheets, as for example through free-foaming systems or twin-conveyor systems. The present invention expressly also comprehends the possibility that, between the emergence of the reaction mixture from the mixing head and the depressurization to atmospheric pressure, there can also be intermediate stations where the prevailing pressure is between the pressure in the mixing head and atmospheric pressure.

In one embodiment of the method according to the present invention, a pressure of ≧40 bar to ≦200 bar, preferably a pressure of ≧60 bar to ≦150 bar and more preferably a pressure of ≧70 bar to ≦120 bar prevails after the step of providing the mixture of compounds A) B) and C). This state can prevail particularly in a mixing head and downstream of a mixing head. The pressure can also be ≧80 bar to ≦120 bar. Pressures of this type will maintain supercritical or near-critical conditions for the blowing agent used.

In a further embodiment of the method according to the present invention, means are disposed in the mixing head or downstream of the mixing head for elevating the flow resistance in the step of discharging the mixture comprising components A), B) and C). Examples of such means include perforated plates, grids, slot diffusers and/or sieves arranged downstream of a mixing chamber of the mixing head. Flow resistance elevation intentionally influences the pressure of the reaction mixture prior to discharge from the mixing head. The pressure thus set can be lower than the pressure during the mixing of the components of the reaction mixture. This makes it possible to influence the formation and expansion of blowing agent droplets or of small bubbles of blowing agent. Means of this type are described in WO 2001/98389 A1 for example.

The examples which follow are offered by way of elucidation, not limitation of the present invention.

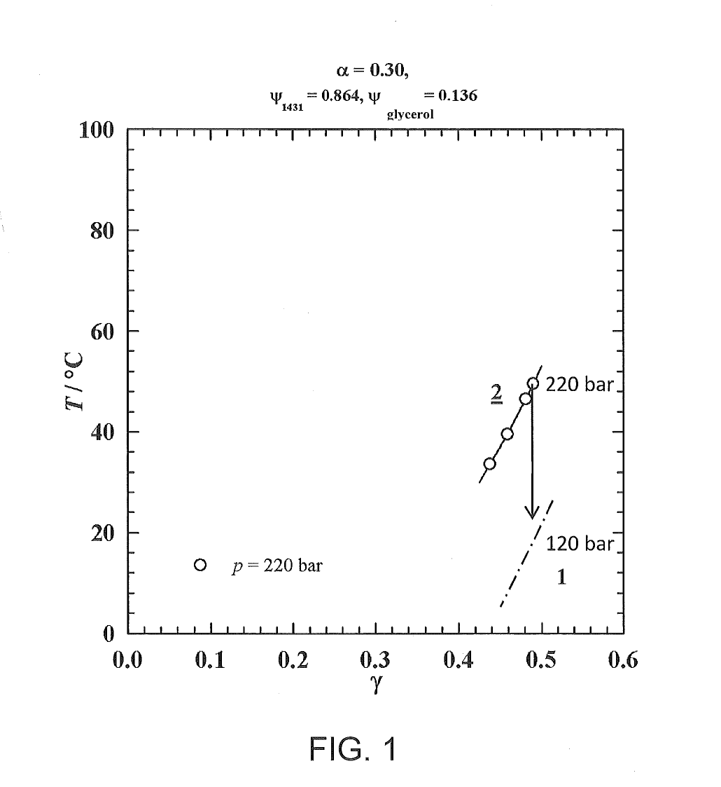

FIG. 1 is a plot of temperature T versus surfactant content γ for a polyol/surfactant system.

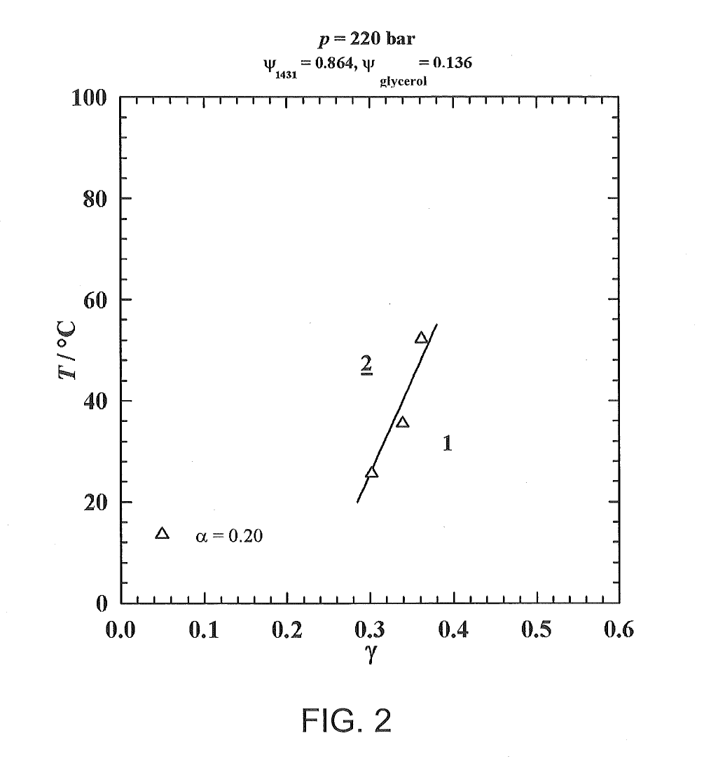

FIG. 2 is a plot of temperature T versus surfactant content γ for a further polyol/surfactant system.

The value α in the examples and figures indicates the relative weight fraction of blowing agent, i.e., of the apolar phase, in the polyol/blowing agent mixture. The value Ψ indicates the mass fractions of the individual components in the polar phase. The value γ indicates the relative weight fraction of surfactant component in the overall composition. In the figures, reference sign 1 denotes a single-phase sector in which microemulsions occur and reference sign 2 denotes a two-phase sector, where the surfactant is a solute in the polar phase.

The individual examples each relate to certain polyol/blowing agent/surfactant systems. Within the examples, various formulations differing in the proportion a of blowing agent were more particularly characterized. For each constant proportion a, the proportion γ of surfactant component was varied. The composition of the surfactant component itself was kept constant in the respective examples. The temperature of the system was recorded and connecting lines were interpolated between the measurement points, in order to determine the boundaries between the single-, two- and three-phase sectors. This resulted in a diagram which is comparable to a Kahlweit-Fisch diagram (M. Kahlweit, R. Strey, Angewandte Chemie International Edition, volume 28(8), page 654 (1985)). The point of intersection of the connecting lines is of particular interest for characterizing the system. Once the position of the intersection point in the coordinate system of γ and T is known, a microemulsion can be expected to occur at a minimally greater proportion γ of surfactant.

### GLOSSARY

Desmophen® VP.PU 1431: bifunctional polyetherester polyol, EO adduct onto a mixture of phthalic anhydride, diethylene glycol and ethylenediamine, with an OH number of 275 to 325 mg KOH/g and a viscosity of 6.5±1.3 Pa s at 25° C.; Bayer MaterialScience AG.
Desmorapid® 726b: catalyst from Bayer MaterialScience AG.
Desmodur® 44V70L: mixture of diphenylmethane 4,4′-diisocyanate (MDI) with isomers and higher-functionality homologs from Bayer MaterialScience AG.
Tween® 80: polysorbate 80 (polyoxyethylene(20) sorbitan monooleate)

### EXAMPLE 1

A polyol composition featuring Desmophen® VP.PU 1431 and glycerol (mass fractions: Ψ₁₄₃₁=0.864 and Ψ_{glycerol}=0.136) and also Tween® 80 (blowing agent fraction α=0.30) was tested at 220 bar, A pressure reduction to 120 bar was also performed. The results are reproduced in FIG. 1. The upper phase boundary, which describes the transition of the system from a single-phase microemulsion (state 1) into state 2, is apparent. A “polyol-in-oil” microemulsion phase and a polyol excess phase coexist in this region.

### EXAMPLE 2

A polyol composition similar to Example 1, featuring Desmophen® VP.PU 1431 and glycerol (mass fractions: Ψ₁₄₃₁=0.864 and Ψ_{glycerol}=0.136) was tested at 220 bar. In this example, however, the proportion a of the blowing agent CO₂ was only 0.20. The results are reproduced in FIG. 2. The upper phase boundary, which describes the transition of the system from a single-phase microemulsion (state 1) into state 2, is apparent. A “polyol-in-oil” microemulsion phase and a polyol excess phase coexist in this region. Compared with FIG. 1, less surfactant is required (the phase boundary extends at lower γ values) to reach state 1. The system has become more efficient because of the lower proportion of blowing agent.

### EXAMPLES 3 AND 4 AND ALSO COMPARATIVE EXAMPLE COMPARATOR 1 TO COMPARATOR 8

CO₂-blown polyurethane foams were produced according to the formulations recited below in Tables 1 to 3. Unless otherwise stated, quantities are given in parts by weight. The mixture of isocyanate-reactive compound A) was mixed with added components such as polyols and catalysts. This mixture was used as polyol component in a standard high-pressure mixing apparatus where it was mixed with blowing agent B) at a pressure of 120 bar. This meant that conditions were supercritical for the blowing agent. This mixture was mixed in a high-pressure mixing head with a polyisocyanate C), which is fed at a pressure of 120 bar. Shot quantity was 60 g/s. The efflux pipe of the mixing head had an inner diameter of 8.5 mm and a length of about 50 cm. A perforated plate having the hole size specified in the tables was fitted in the efflux pipe downstream of the mixing head in the inventive and some comparative examples. This made it possible to set the pressure in the mixing head in a controlled manner and achieve a slower pressure reduction in the reaction mixture. The perforated plate makes it possible to set the pressure in a controlled manner. Comparative Examples 1-4, that were deliberately set to a lower pressure compared with Examples 1 and 2, have a distinctly higher apparent density and, what is more, Comparative Examples 1 and 3 are coarsely cellular. Comparative Examples 5 and 6, which were produced without Tween® 80 but with supercritical CO₂ as blowing agent, have a higher apparent density and are inhomogeneous and coarsely cellular. Comparative Examples 7 and 8, produced without Tween® 80 and with subcritical CO₂ have a very high apparent density.

TABLE 1

| Components | Example 3 | Example 4 | Comparator 1 | Comparator 2 |
|---|---|---|---|---|
| Desmophen ® VP.PU1431 | 95.00 | 95.00 | 95.00 | 95.00 |
| glycerol | 15.00 | 15.00 | 15.00 | 15.00 |
| Tween ® 80 | 137.50 | 137.50 | 137.50 | 137.50 |
| DBTDL | 0.09 | 0.09 | 0.09 | 0.09 |
| Desmorapid ® 726b | 0.47 | 0.47 | 0.47 | 0.47 |
| CO₂ | 27.50 | 28.60 | 27.50 | 27.50 |
| Desmodur ® 44V70L | 161.23 | 177.35 | 161.23 | 161.23 |
| Process parameters | | | | |
| isocyanate temperature [° C.] | 34 | 34 | 34 | 34 |
| polyol temperature [° C.] | 35 | 36 | 35 | 35 |
| pressure in mixing chamber [bar] | 118-104 | 85-75 | 35-32 | 1.5-1.2 |
| perforated plate [mm] | 0.8 | 0.8 | 1.2 | none |
| pipe diameter [mm] | 8.5 | 8.5 | 8.5 | 8.5 |
| PU foam properties | | | | |
| free-rise density of core [kg/m³] | 67 | 67 | 79 | 121 |
| comment | finely | finely | coarsely | high |
| | cellular | cellular | cellular | apparent |
| | | | | density |
| Emulsion parameters | | | | |
| γ value of CO₂ polyol emulsion | 0.50 | 0.50 | 0.50 | 0.50 |
| weight fraction of fatty acid [%] | 6.38 | 6.14 | 6.38 | 6.38 |
| weight fraction of CO₂ [%] | 6.30 | 6.30 | 6.30 | 6.30 |
| weight fraction of Tween ® 80 [%] | 31.48 | 30.29 | 31.48 | 31.48 |

TABLE 2

| Components | Comparator 3 | Comparator 4 | Comparator 5 | Comparator 6 |
|---|---|---|---|---|
| Desmophen ® VP.PU1431 | 95.00 | 95.00 | 95.00 | 95.00 |
| glycerol | 15.00 | 15.00 | 15.00 | 15.00 |
| Tween ® 80 | 137.50 | 137.50 | | |
| DBTDL | 0.09 | 0.09 | 0.06 | 0.06 |
| Desmorapid ® 726b | 0.47 | 0.47 | 0.29 | 0.29 |
| CO₂ | 28.60 | 28.60 | 16.70 | 17.60 |
| Desmodur ® 44V70L | 177.35 | 177.35 | 137.89 | 151.67 |
| Process parameters | | | | |
| isocyanate temperature [° C.] | 34 | 34 | 34 | 36 |
| polyol temperature [° C.] | 35 | 35 | 34 | 35 |
| pressure in mixing chamber | 35-31 | 2.4-2.1 | 123-114 | 114-80 |
| [bar] | | | | |
| perforated plate [mm] | 1.2 | none | 0.7 | 0.8 |
| pipe diameter [mm] | 8.5 | 8.5 | 8.5 | 8.5 |
| PU foam properties | | | | |
| free-rise density of core [kg/m³] | 80 | 140 | 84 | 90 |
| comment | coarsely | high | coarsely | coarsely |
| | cellular | apparent | cellular, | cellular, |
| | | density | inhomogeneous | inhomogeneous |
| Emulsion parameters | | | | |
| γ value of CO₂ polyol emulsion | 0.50 | 0.50 | 0.00 | 0.00 |
| weight fraction of fatty acid | 6.14 | 6.14 | 0.00 | 0.00 |
| [%] | | | | |
| weight fraction of CO₂ [%] | 6.30 | 6.30 | 6.30 | 6.29 |
| weight fraction of Tween ® 80 | 30.29 | 30.29 | 0 | 0 |
| [%] | | | | |

TABLE 3

| Components | Comparator 7 | Comparator 8 |
|---|---|---|
| Desmophen ® VP.PU1431 | 95.00 | 95.00 |
| glycerol | 15.00 | 15.00 |
| Tween ® 80 | | |
| DBTDL | 0.06 | 0.06 |
| Desmorapid ® 726b | 0.29 | 0.29 |
| CO₂ | 16.70 | 17.60 |
| Desmodur ® 44V70L | 137.89 | 151.67 |
| Process parameters | | |
| isocyanate temperature [° C.] | 34 | 35 |
| polyol temperature [° C.] | 35 | 34 |
| pressure in mixing chamber [bar] | 2-1.4 | 1.5-1 |
| perforated plate [mm] | none | none |
| pipe diameter [mm] | 8.5 | 8.5 |
| PU foam properties | | |
| free-rise density of core [kg/m³] | 262 | 265 |
| comment | high apparent | high apparent |
| | density | density |
| Emulsion parameters | | |
| γ value of CO₂ polyol emulsion | 0.00 | 0.00 |
| weight fraction of fatty acid [%] | 0.00 | 0.00 |
| weight fraction of CO₂ [%] | 6.30 | 6.29 |
| weight fraction of Tween ® 80 | 0 | 0 |
| [%] | | |

1-15. (canceled)

16. A polyurethane foam obtained from the reaction of a mixture comprising:
A) an isocyanate-reactive compound;
B) a blowing agent selected from the group consisting of a linear, a branched or a cyclic C₁-C₆ hydrocarbon, a linear, a branched or a cyclic C₁-C₆ (hydro)fluorocarbon, N₂, O₂, argon and/or CO₂, wherein said blowing agent B) is in the supercritical or near-critical state; and
C) a polyisocyanate;
wherein said isocyanate-active compound A) comprises a hydrophobic portion and a hydrophilic portion and has an average hydroxyl functionality of more than 1,
wherein the hydrophobic portion comprises a saturated or unsaturated hydrocarbonaceous chain having 6 or more carbon atoms, and
wherein the hydrophilic portion comprises alkylene oxide units and/or ester units.

17. The polyurethane foam as claimed in claim 16 wherein the isocyanate-reactive compound has an average hydroxyl functionality of ≧1.5 to ≦5.

18. The polyurethane foam as claimed in claim 16 wherein said isocyanate-reactive compound A) has a hydroxyl number of ≧50 mg KOH/g to ≦500 mg KOH/g.

19. The polyurethane foam as claimed in claim 16 wherein the proportion of said isocyanate-reactive compound A) is ≧0.5% by weight to ≦40% by weight, based on the overall weight of the mixture.

20. The polyurethane foam as claimed in claim 16 wherein the hydrophilic portion of said isocyanate-reactive compound A) comprises an intro-esterified fatty acid and the proportion of the intro-esterified fatty acid is ≧0.5% by weight to ≦25% by weight, based on the overall weight of the mixture.

21. The polyurethane foam as claimed in claim 16 wherein said isocyanate-reactive compound A) is obtained from the reaction of a partially alkoxylated polyol with a fatty acid.

22. The polyurethane foam as claimed in claim 21 wherein said isocyanate-reactive compound A) comprises a carboxylic ester of an alkoxylated sorbitan.

23. The polyurethane foam as claimed in claim 21 wherein the isocyanate-reactive compound is an ester of the general formula (I): 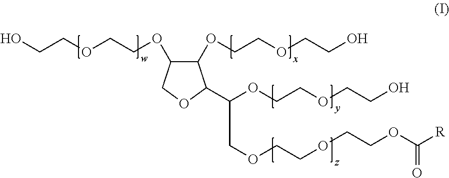
where w+x+y+z≧16 to ≦22 and R is a saturated or unsaturated hydrocarbonaceous moiety of ≧12 to ≦18 carbon atoms.

24. The polyurethane foam as claimed in claim 16 wherein the reaction mixture further comprises a polyetherester polyol having a hydroxyl number of ≧200 mg KOH/g to ≦600 mg KOH/g and a short-chain polyol having a hydroxyl number of ≧800 mg KOH/g.

25. The polyurethane foam as claimed in claim 16 wherein the proportion of blowing agent B) is ≧2% by weight to ≦10% by weight, based on the overall weight of the mixture.

26. The polyurethane foam as claimed in claim 16 wherein said polyisocyanate component C) comprises monomeric and/or polymeric diphenylmethane 4,4′-diisocyanate.

27. The polyurethane foam as claimed in claim 16 with an apparent density of ≧20 kg/m³ to ≦160 kg/m³.

28. A method for producing a polyurethane foam comprising the steps of:
providing a mixture of compounds A), B) and C) as is described in claim 16 in a mixing head; and
discharging the mixture from the mixing head, wherein the pressure prevailing in the mixture is lowered to atmospheric pressure in the course of discharge.

29. The method as claimed in claim 28 wherein a pressure of ≧40 bar to ≦200 bar prevails after the step of providing the mixture of compounds A), B) and C).

30. The method as claimed in claim 28 wherein means are disposed in the mixing head or downstream of the mixing head for elevating the flow resistance in the step of discharging the mixture comprising components A), B) and C).
